(19) United States
(12) Patent Application Publication
(10) Pub. No.: US 2005/0190990 A1
(43) Pub. Date: Sep. 1, 2005

(54) Method and apparatus for combining a plurality of images

(76) Inventors: Peter Jeffrey Burt, Princeton, NJ (US); Gooitzen Van Der Wal, Hopewell, NJ (US); Chao Zhang, Belle Mead, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(21) Appl. No.: 11/044,155

(22) Filed: Jan. 27, 2005

Related U.S. Application Data
(60) Provisional application No. 60/540,100, filed on Jan. 27, 2004.

(51) Int. Cl. G03G 9/00; G06K 9/36; G06K 9/32

(52) U.S. Cl. 382/294; 382/284

(57) ABSTRACT

A method and apparatus for combining a plurality of images is disclosed. In one embodiment, at least one signal component is determined from a plurality of source images using feature selective fusion. At least one color component is determined from the plurality of source images using color fusion. An output image is formed from the at least one signal component and the at least one color component. In another embodiment, at least one image component is determined from a plurality of source images using feature selective fusion. An output image is formed from the at least one image component using color fusion.

### CROSS-REFERENCE TO RELATED APPLICATIONS

This application claims benefit of U.S. provisional patent application Ser. No. 60/540,100, filed Jan. 27, 2004, which is herein incorporated by reference.

### BACKGROUND OF THE INVENTION

1. Field of the Invention

Embodiments of the present invention generally relate to a method and apparatus for combining images. More particularly, the present invention relates to image fusion techniques.

2. Description of the Related Art

Image fusion is the process of combining two or more source images of a given scene in order to construct a new image with enhanced information content for presentation to a human observer. For example, the source images may be infrared (IR) and visible camera images of the scene obtained from approximately the same vantage point.

There are two broad classes of image fusion algorithms. The first class is color fusion and the second class is feature selective fusion.

Both classes of image fusion have strengths as well as limitations. Color fusion makes use of human color vision to convey more information to an observer than can be provided in the comparable monochrome display. Color fusion also allows intuitive perception of materials, e.g., vegetation, roads, vehicles, and the like. However, color fusion often results in reduced contrast of some features in the scene, making those features more difficult to see. Feature selective fusion preserves selected scene features at full contrast. Feature selective fusion also provides a more general framework for combining images than does color fusion. However, feature selective fusion may discard information that is “good”.

Therefore, there is a need in the art for an image fusion approach that maintains full contrast and allows for intuitive perception while reducing the amount of relevant information that is discarded.

### SUMMARY OF THE INVENTION

The present invention generally relates to a method and apparatus for combining a plurality of images. In one embodiment, at least one signal component is determined from a plurality of source images using feature selective fusion. At least one color component is determined from the plurality of source images using color fusion. An output image is formed from the at least one signal component and the at least one color component.

In another embodiment, at least one image component is determined from a plurality of source images using feature selective fusion. An output image is formed from the at least one image component using color fusion.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an example of color fusion as a direct mapping;

FIG. 2 illustrates an example of color fusion as a weighted average;

FIG. 3 illustrates a general example of color fusion as a weighted average;

FIG. 4 illustrates an example of feature selection;

FIG. 5 illustrates a method of combining images according to one embodiment of the present invention;

FIG. 6 illustrates an apparatus for use with the method of FIG. 5 according to one embodiment of the present invention;

FIG. 7 illustrates an example of the method of FIG. 5 in accordance with the present invention;

FIG. 8 illustrates an example of the method of FIG. 5 in accordance with the present invention;

FIG. 9 illustrates a method of combining images according to one embodiment of the present invention;

FIG. 10 illustrates an apparatus for use with the method of FIG. 9 according to one embodiment of the present invention;

FIG. 11 illustrates an example of the method of FIG. 9 in accordance with the present invention;

FIG. 12 illustrates an apparatus for use with the method of FIG. 9 according to one embodiment of the present invention;

FIG. 13 illustrates an example of the method of FIG. 9 in accordance with the present invention; and

FIG. 14 illustrates a block diagram of an image processing device or system according to one embodiment of the present invention.

### DETAILED DESCRIPTION

The present invention discloses a method and apparatus for image fusion that combines the basic color and feature selective methods outlined above to achieve the beneficial qualities of both while avoiding the shortcomings of each.

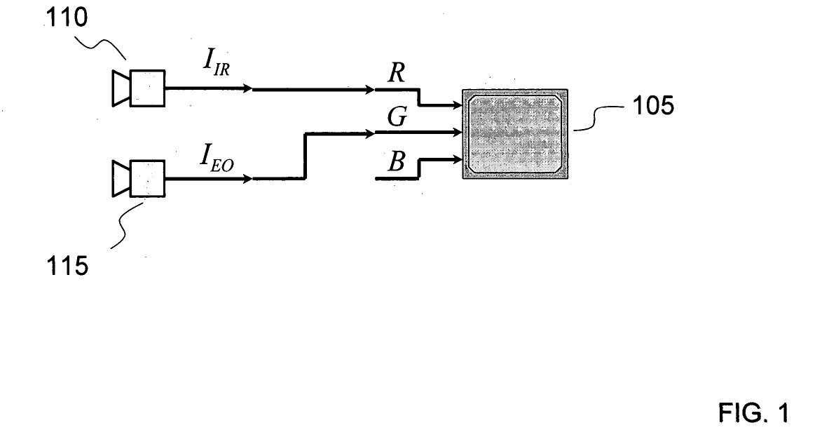

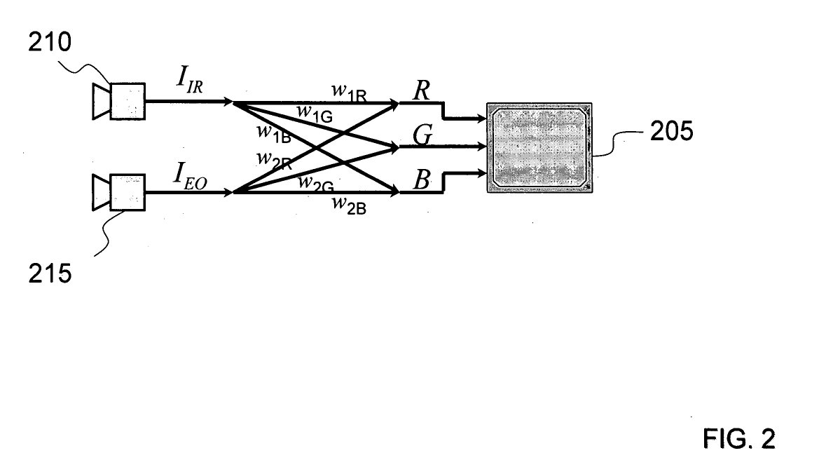

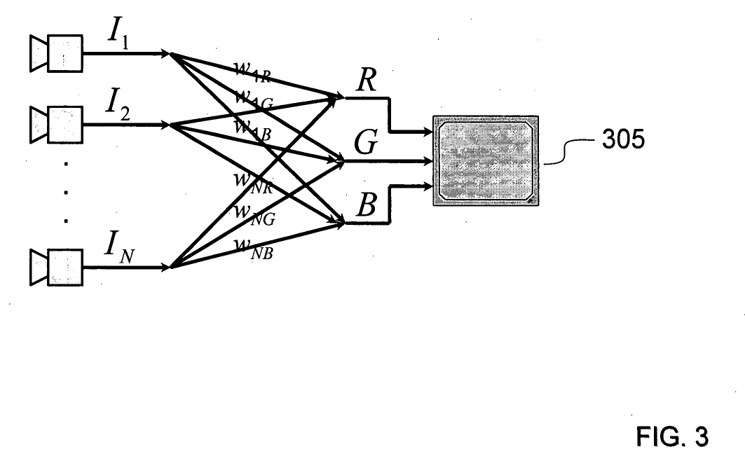

In the color fusion, multiple images are combined to form an output image. One example of color fusion is color fusion as a direct mapping. This type of color fusion is shown in FIG. 1. In FIG. 1, a display 105 having red R, green G, and blue B inputs is shown. An IR image from IR camera 110 is mapped directly to the R input of display 105. An electro-optical (EO) image from EO camera 115 is mapped directly to the G input of display 105. Another example of color fusion is color fusion as a weighted average. In this example, multiple monochrome images, are combined through a weighted average in the pixel domain to form a three-component color image for presentation on a standard color display. Each output color channel is made up of a weighted sum of the input source images. Weights are often chosen that result in “natural” looking color such as green trees and blue sky, even though source images may represent very different spectral frequency bands outside the visible range. This type of color fusion is shown in FIG. 2. In FIG. 2, a display 205 having red R, green G, and blue B inputs is shown. The R, G, and B inputs are made up of a weighted sum of the input source images from IR camera 210 and EO camera 215. A more general example of color fusion is shown in FIG. 3. In FIG. 3, a plurality of image collection devices 301-1 . . . N having outputs I₁ . . . I_{N} is shown. The R, G, and B inputs for display 305 are made up of a weighted sum of the input source images from the plurality of image collection devices.

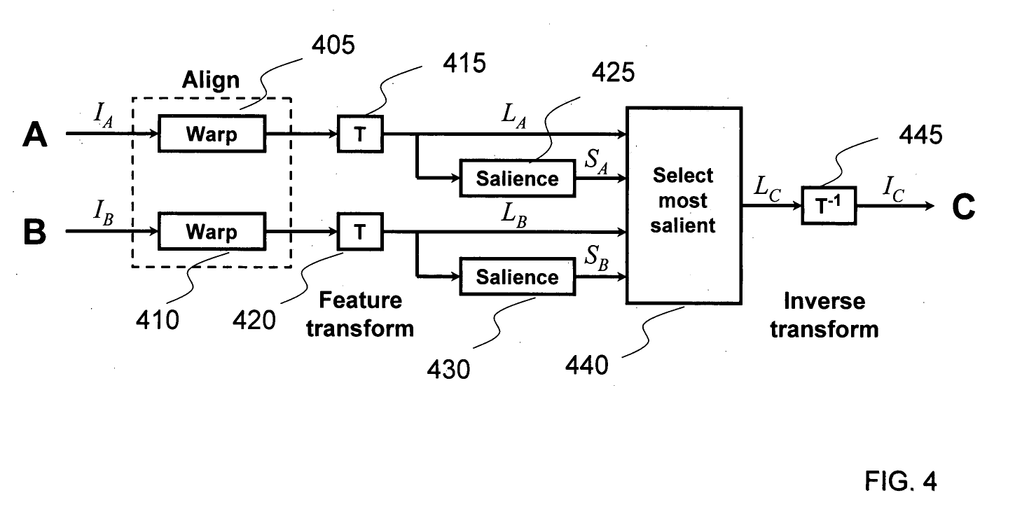

In feature selection, images are combined in a pyramid or wavelet image transform domain and the combination is achieved through selection of one image source or another at each sample position in the transform. Selection may be binary or through weighted average. This method is also called feature fusion, pattern selective, contrast selective, or “choose best” fusion. Feature fusion provides the selection, at any image location, of the source that has the best image quality, e.g., best contrast, best resolution, best focus, best coverage. An example of feature fusion (e.g., “choose best” selection) is illustrated in FIG. 4. In FIG. 4, the input images I_{A}, I_{B} are aligned using warpers 405, 410. The aligned images are then transformed using feature transforms (e.g., Gaussian and Laplacian transforms) 415, 420 to produce transformed images L_{A}, L_{B}. A salience S_{A}, S_{B} for each sample position in each transformed image is determined by salience calculators 425, 430. An output transformed image L_{C} is formed from those portions of the transformed images having the highest salience by selector 440. The output transformed image is determined as follows:
At each location (e.g., sample position) i, j and scale k:

$${L}_{C} ( ijk ) = \{ \begin{matrix}{L}_{A} ( ijk ) if {S}_{A} ( ijk ) > {S}_{B} ( ijk ) \\ {L}_{B} ( ijk ) otherwise\end{matrix}$$

where L_{A}, L_{B} comprise transformed images from sources A and B, and S_{A}, S_{B} comprise a salience of each transformed image. Salience may be determined as follows:
At each location (e.g., sample position) i, j and scale k:
Salience measures for fusion based on contrast may be represented as
S_{I}(ijk)=|L_{I}(ijk).
Salience measures for merging based on support may be represented as
S_{I}(ijk)=G_{M}(ijk),
where M is a mask indicating a support area for image I.
A combined salience measure may be represented as
S_{I}(ijk)=G_{M}(ijk)|L_{I}(ijk)|.
The output transformed image L_{C} is then inverse transformed by inverse transformer 445 to provide combined image I_{C}.

The method and apparatus of the present invention discloses color plus feature fusion (CFF), where multiple source images may be combined to form an image for viewing. In one embodiment, the multiple source images are both monochrome and color and are combined to form a color image for viewing. The output image may be defined in terms of three standard spectral bands used in display devices, typically red, green and blue component images. Alternatively the output image may be described in terms of a three-channel coordinate system in which one channel represents intensity (or brightness or luminance) and the other two represent color. For example the color channels may be hue and saturation or opponent colors such as red-green and blue-yellow, or color difference signals, e.g., Red-Luminance, Blue-Luminance. In one embodiment CFF may operate in one color space format, e.g., Hue, Saturation, Intensity (HSI), and provide an output in another color space format, e.g, Red, Green, Blue (RGB).

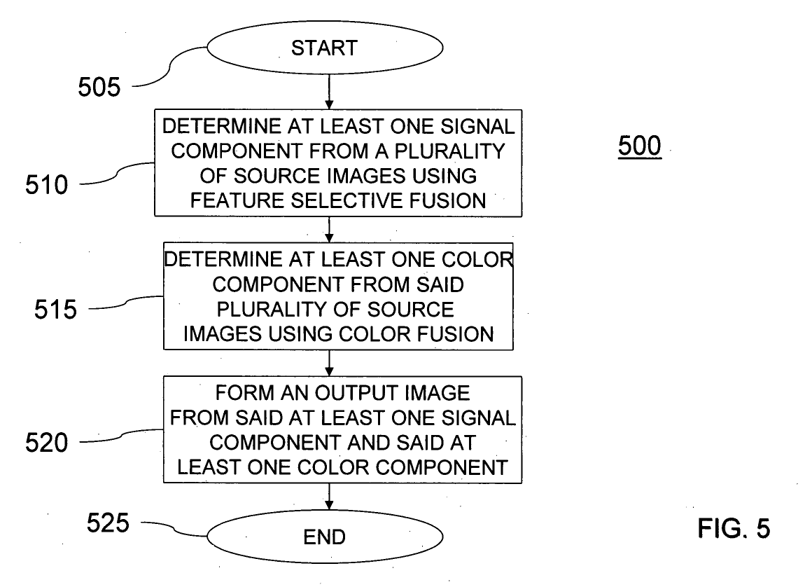

FIG. 5 illustrates a method 500 of combining a plurality of source images according to one embodiment of the present invention. Method 500 begins at step 505 and proceeds to step 510. In step 510, at least one signal component from a plurality of source images is determined using feature selective fusion. In one embodiment, the at least one signal component may be a luminance, a brightness, or an intensity. In step 515, at least one color component from the plurality of source images is determined using color fusion. In one embodiment, the color component may comprise hue and saturation components. In step 520, an output image is formed from the at least one signal component and the at least one color component.

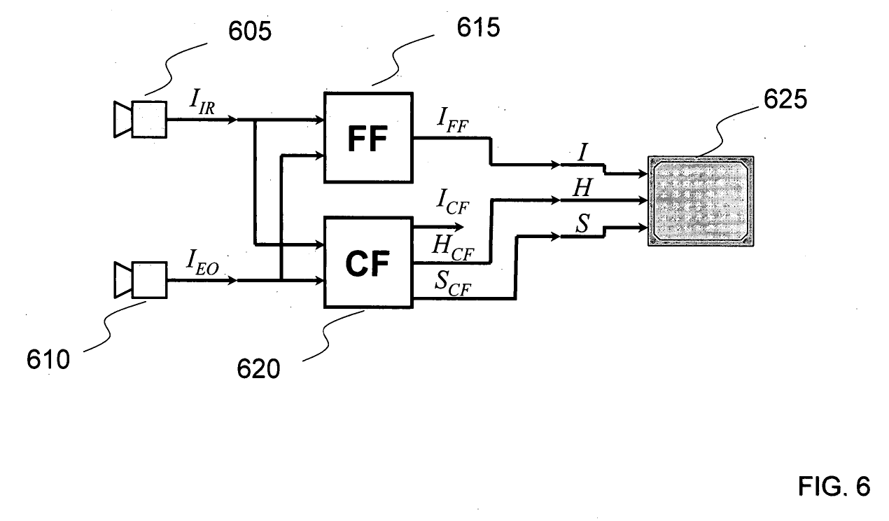

FIG. 6 illustrates one embodiment of an apparatus that may utilize the method described in FIG. 5. In FIG. 6, an infrared camera 605 and an electro-optical camera 610 provide images I_{IR}, I_{EO} to feature fusion element 615 and color fusion element 620. Feature fusion element 615 provides one of an intensity, luminance, or brightness component I_{FF} to display 625. Color fusion element 620 provides a hue component H_{CF} and saturation component S_{CF} to display 625. The intensity, luminance, or brightness element I_{CF} from color fusion element 620 may be discarded. The process illustrated in FIG. 6 provides the same color output as a standard color fusion process but provides the higher contrast typical of a feature fusion process.

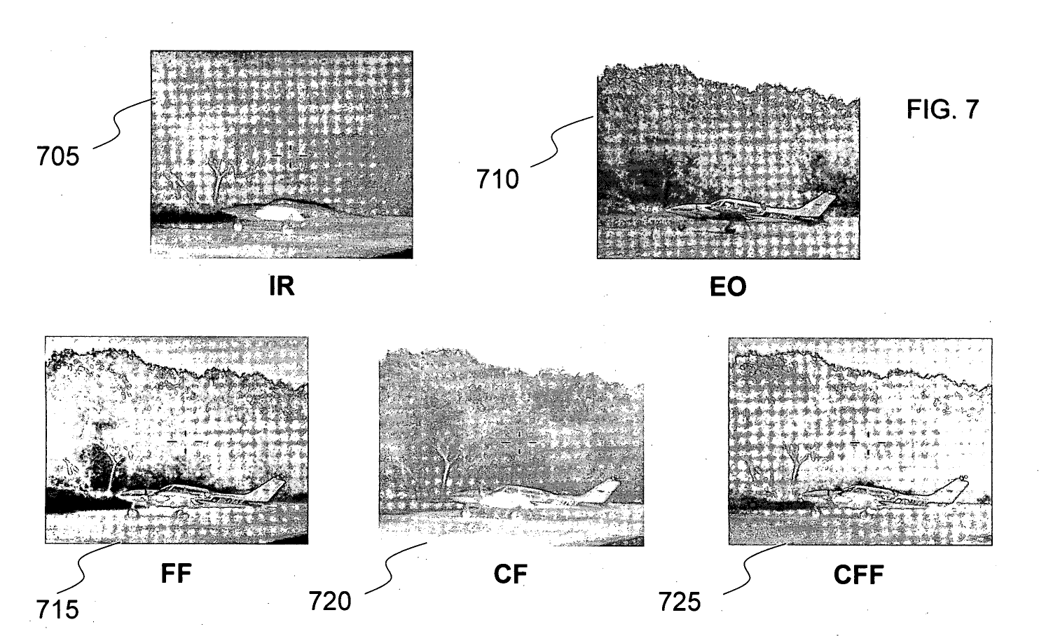

FIG. 7 illustrates the method of FIG. 5 using images of an airplane from multiple sources. An infrared image 705 and an electro-optical image 710 of an airplane are provided. Images resulting from feature fusion 715, color fusion 720, and color plus feature fusion 725 are shown.

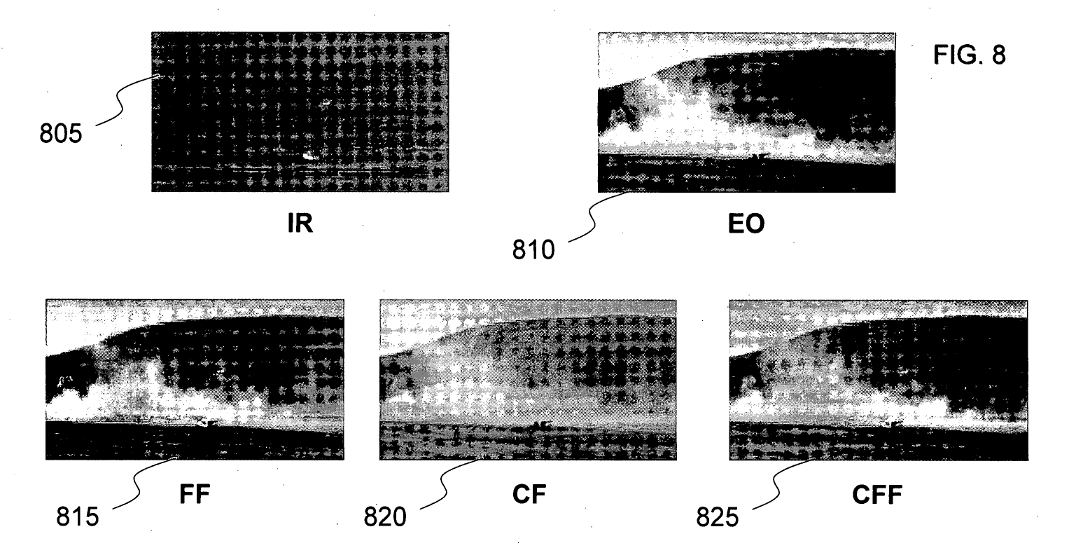

FIG. 8 illustrates the method of FIG. 5 using images having a smokescreen from multiple sources. An infrared image 805 and an electro-optical image 810 of scene having a smokescreen are provided. Images resulting from feature fusion 815, color fusion 820, and color plus feature fusion 825 are shown.

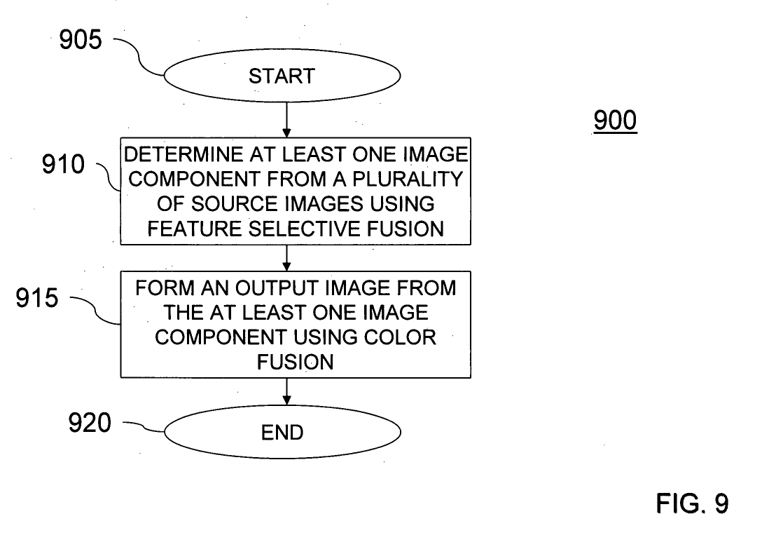

FIG. 9 illustrates a method 900 of combining a plurality of source images according to one embodiment of the present invention. Method 900 begins at step 905 and proceeds to step 910. In step 910, at least one image component from a plurality of source images is determined using feature selective fusion. In step 915, an output image is formed from the at least one image component using color fusion.

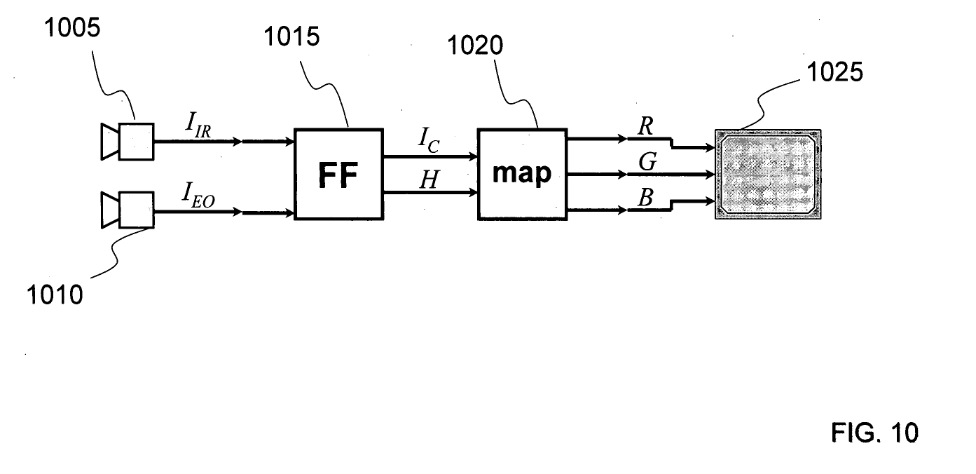

FIG. 10 illustrates one embodiment of an apparatus that may utilize the method described in FIG. 9. In FIG. 10, an infrared camera 1005 and an electro-optical camera 1010 provide images I_{IR}, I_{EO} to feature fusion element 1015 and color fusion element 1020. Feature fusion element 1015 provides an intensity component IC and a source selection component H to color fusion or mapping element 1020. Mapping element 1020 converts the intensity component and source selection component to a color space. In one embodiment, the color space comprises red R, green G, and blue B bands. The output of mapping element 1020 is provided to display 1025. In this embodiment, the resultant colors shown on display 1025 indicate the source, e.g., the image (I_{IR} or I_{EO}) from which that portion of the resultant image originated. Since selection takes place in a multiresolution pyramid domain, selection information (here shown as H) is first combined across resolution levels then is used to color the fused image.

In one embodiment, mapping element 1020 may be implemented as follows:
At each point (ijk):

$$Feature selection \text{:}$$

$$FS = \{ \begin{matrix}1 \\ 0\end{matrix} \begin{matrix}if \\ otherwise\end{matrix} \begin{matrix}{S}_{A} > {S}_{B} \\ \end{matrix} \\ {L}_{c} = FS \cdot {L}_{A} + ( 1 - FS ) \cdot {L}_{B} \\ \begin{matrix}Salience \text{:} & For H < 0 : & For H > 0 : \\ H = \{ \begin{matrix}1 \\ - 1\end{matrix} \begin{matrix}if \\ otherwise\end{matrix} \begin{matrix}{S}_{A} > {S}_{B} \\ \end{matrix} & R = I ( 1 + \frac{2}{3} H ) & G = I ( 1 + \frac{2}{3} H ) \\ & G = B = I ( 1 - \frac{1}{3} H ) & R = B = I ( 1 - \frac{1}{3} H )\end{matrix}$$

where S_{A} comprises a salience of I_{IR} and S_{B} comprises a salience of I_{EO}, L_{A} comprises the transformed image of I_{IR} and L_{B} comprises the transformed image of I_{EO}, and R, G, and B respectively comprise red, green, and blue channels.

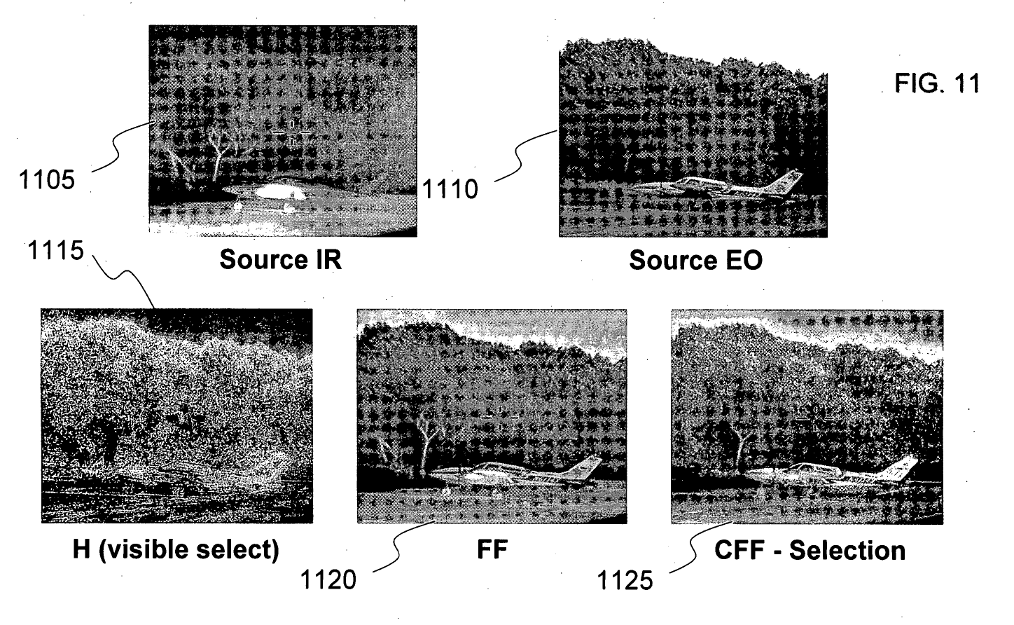

FIG. 11 illustrates the method of FIG. 9 using images of an airplane from multiple sources. An infrared image 1105 and an electro-optical image 1110 of an airplane are provided. Images resulting from salience map 1115, feature fusion 1120, and color plus feature fusion 1125 are shown.

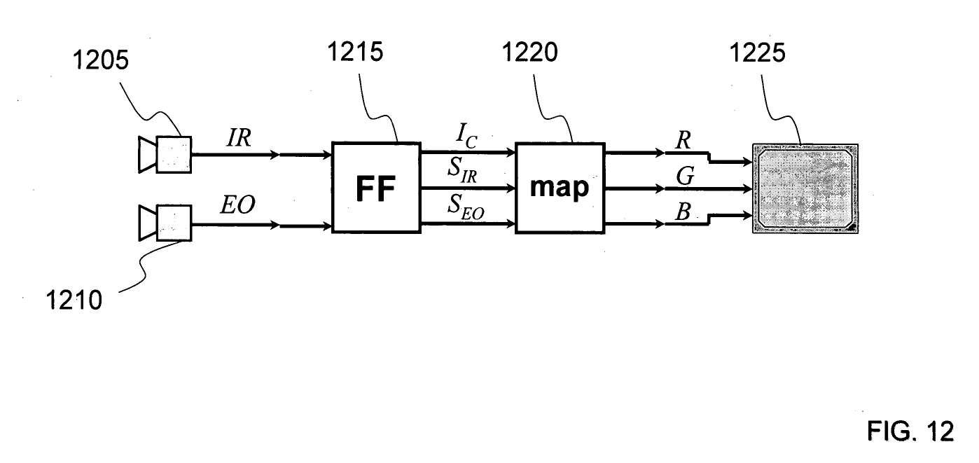

FIG. 12 illustrates one embodiment of an apparatus that may utilize the method described in FIG. 9. In FIG. 12, an infrared camera 1205 and an electro-optical camera 1210 provide images I_{IR}, I_{EO} to feature fusion element 1215 and color fusion element 1220. Feature fusion element 1215 provides an intensity component IC and a plurality of salience components S_{IR}, S_{EO} to color fusion or mapping element 1220. Mapping element 1220 converts the intensity component and source salience components to a color space. In one embodiment, the color space comprises red R, green G, and blue B bands. The output of mapping element 1220 is provided to display 1225. In this embodiment, the resultant colors shown on display 1225 indicate a degree to which a salience of one source dominates. (Salience is used to control the selection process in feature fusion. Salience may represent specific information about a feature in the source images, such as the occurrence of target objects or target features or it may simply represent the local contrast of each source.) For example the output may be colored red when one source is more salient, green when the other is dominant and gray (no color) when both sources have roughly the same salience.

In one embodiment, mapping element 1020 may be implemented as follows:

$$\begin{matrix}For {S}_{IR} > {S}_{EO} : R = I ( 1 + \frac{2}{3} \frac{{S}_{IR} - {S}_{EO}}{{S}_{IR} + {S}_{EO}} ) \\ G = B = I ( 1 - \frac{1}{3} \frac{{S}_{IR} - {S}_{EO}}{{S}_{IR} + {S}_{EO}} )\end{matrix}$$

$$\begin{matrix} For {S}_{EO} > {S}_{IR} : & G = I ( 1 + \frac{2}{3} \frac{{S}_{IR} - {S}_{EO}}{{S}_{IR} + {S}_{EO}} ) \\ & R = B = I ( 1 - \frac{1}{3} \frac{{S}_{IR} - {S}_{EO}}{{S}_{IR} + {S}_{EO}} )\end{matrix}$$

where S_{IR} comprises a salience of the infrared source image, S_{EO} indicates a salience of electro-optical source image, and R, G, and B respectively comprise red, green, and blue channels.

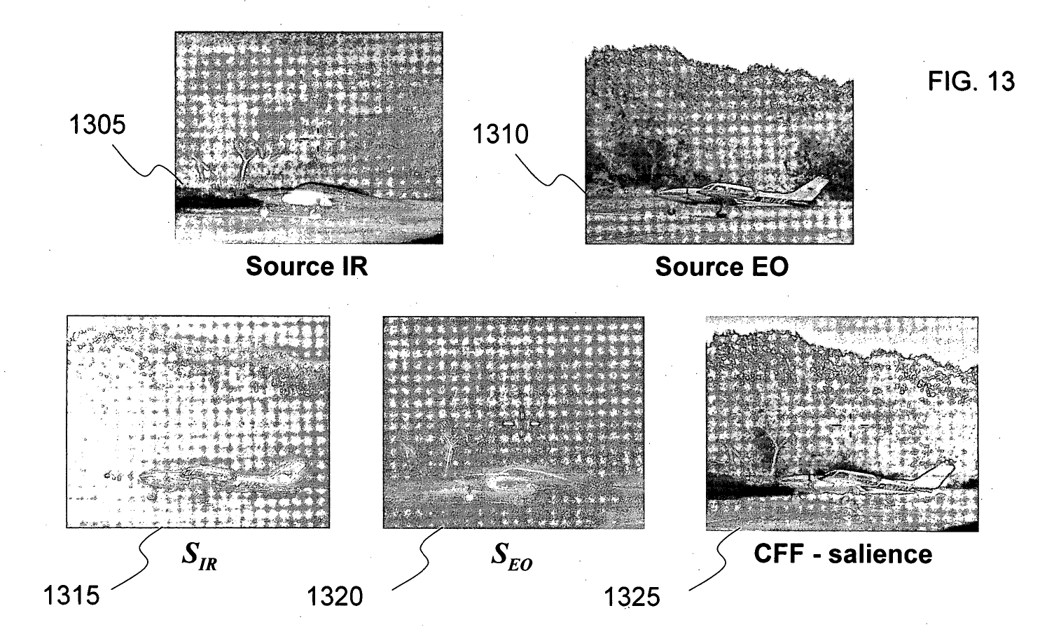

FIG. 13 illustrates the method of FIG. 9 using images of an airplane from multiple sources. An infrared image 1305 and an electro-optical image 1310 of an airplane are provided. Images resulting from IR salience map 1315, EO salience map 1320, and color plus feature fusion 1325 are shown.

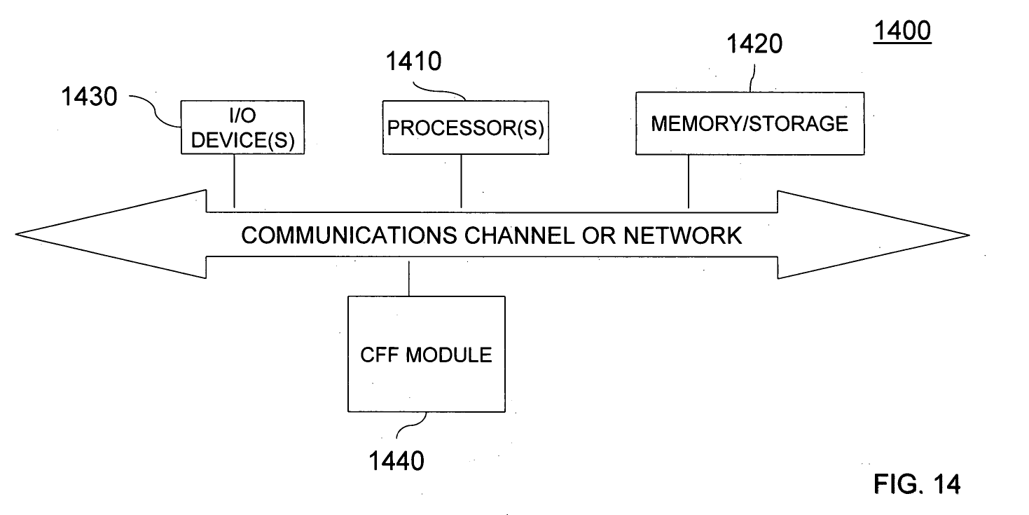

FIG. 14 illustrates a block diagram of an image processing device or system 1400 of the present invention. Specifically, the system can be employed to provide fused images. In one embodiment, the image processing device or system 1400 is implemented using a general purpose computer or any other hardware equivalents.

Thus, image processing device or system 1400 comprises a processor (CPU) 1410, a memory 1420, e.g., random access memory (RAM) and/or read only memory (ROM), a color plus feature fusion (CFF) module 1440, and various input/output devices 1430, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands).

It should be understood that the CFF module 1440 can be implemented as one or more physical devices that are coupled to the CPU 1410 through a communication channel. Alternatively, the CFF module 1440 can be represented by one or more software applications (or even a combination of software and hardware, e.g., using application specific integrated circuits (ASIC)), where the software is loaded from a storage medium, (e.g., a magnetic or optical drive or diskette or field programmable gate array (FPGA)) and operated by the CPU in the memory 1420 of the computer. As such, the CFF module 1440 (including associated data structures) of the present invention can be stored on a computer readable medium, e.g., RAM memory, magnetic or optical drive or diskette and the like.

In one embodiment, an enhancement is performed in combination with color plus feature fusion. Enhancement may involve point methods in the image domain. Point methods may include contrast stretching, e.g., using histogram specification. Enhancement may involve region methods in the pyramid domain, e.g., using Gaussian and Laplacian transforms. Region methods may include sharpening, e.g., using spectrum specification. Enhancement may also involve temporal methods during the alignment process. Temporal methods may be utilized for stabilization and noise reduction.

In one embodiment, color plus feature fusion (CFF) may be utilized in a video surveillance system. Fusion and enhancement may be provided using position and scale invariant basis functions. Analysis may be provided using multi-scale feature sets and fast hierarchical search. Compression is provided using a compact representation retaining salient structure.

CFF maintains the contrast of feature fusion and provides intuitive perception of materials. CFF also provides a general framework for image combination and for video processing systems. Where processing latency is important, CFF embodiments may achieve sub-frame latency.

The present invention has described CFF using just two source cameras. It should be understood that the method and apparatus may be applied with any number of source cameras, just as standard color and feature fusion methods may be applied to any number of source cameras. Also the source images may originate from any image source, and need not be limited to cameras.

Example apparatus embodiments of the present invention are described such that only one presentation format is shown. It should be apparent to one skilled in the art that a signal component or a color component may be a band in a color space (e.g., R, G, and B bands in the RGB domain; Hue, Saturation, and Intensity in the HSI domain; Luminance, Color U, and Color V in the YUV space, and so on). Each source image may contain only one band as in IR, or multiple bands as in EO.

While the foregoing is directed to embodiments of the present invention, other and further embodiments of the invention may be devised without departing from the basic scope thereof, and the scope thereof is determined by the claims that follow.

1. A method of combining a plurality of source images, comprising:
determining at least one signal component from said plurality of source images using feature selective fusion;
determining at least one color component from said plurality of source images using color fusion; and
forming an output image from said at least one signal component and said at least one color component.

2. The method of claim 1, wherein said at least one signal component comprises one of a luminance, a brightness and an intensity.

3. The method of claim 1, wherein said at least one color component comprises a hue and a saturation, a plurality of color difference signals, or a Color U and a Color V.

4. A method of combining a plurality of source images, comprising:
determining at least one image component from said plurality of source images using feature selective fusion; and
forming an output image from the at least one image component using color fusion.

5. The method of claim 4, wherein the at least one image component comprises an intensity and a source selection.

6. The method of claim 5, wherein forming said output image comprises mapping said intensity and said source selection to a color space.

7. The method of claim 6, wherein said color space comprises at least two of a red band, a green band, and a blue band.

8. The method of claim 4, wherein the at least one image component comprises an intensity, a first salience and a second salience.

9. The method of claim 8, wherein forming said output image comprises mapping said intensity, said first salience, and said second salience to a color space.

10. The method of claim 9, wherein said plurality of color channels comprise at least two of a red band, a green band, and a blue band.

11. An apparatus for combining a plurality of source images, comprising:
means for determining at least one image component from said plurality of source images using feature selective fusion; and
means for forming an output image from the at least one image component using color fusion.

12. The apparatus of claim 11, wherein the at least one image component comprises an intensity and a source selection.

13. The apparatus of claim 12, wherein forming said output image comprises mapping said intensity and said source selection to a color space.

14. The apparatus of claim 13, wherein said plurality of color channels comprise at least two of a red band, a green band, and a blue band.

15. The apparatus of claim 11, wherein the at least one image component comprises an intensity, a first salience and a second salience.

16. The apparatus of claim 15, wherein forming said output image comprises mapping said intensity, said first salience, and said second salience to a color space.

17. The apparatus of claim 16, wherein said plurality of color channels comprise at least two of a red band, a green band, and a blue band.
